(19) United States
(12) Patent Application Publication
(10) Pub. No.: US 2026/0091553 A1
(43) Pub. Date: Apr. 2, 2026

(54) PRE-PROCESSING FILAMENT MATERIAL

(71) Applicant: INTERNATIONAL BUSINESS MACHINES CORPORATION, Armonk, NY (US)

(72) Inventors: Hamid Majdabadi, OTTAWA (CA); Jeremy R. Fox, Georgetown, TX (US); Martin G. Keen, Cary, NC (US); Sarbajit Kumar Rakshit, Kolkata (IN)

(21) Appl. No.: 18/903,461

(22) Filed: Oct. 1, 2024

(51) Int. Cl. B29C 64/314; B29C 64/118; B29C 64/393; B33Y 10/00; B33Y 30/00; B33Y 40/10; B33Y 50/02

(52) U.S. Cl. CPC B29C 64/314; B29C 64/393; B33Y 10/00; B33Y 30/00; B33Y 40/10; B33Y 50/02; B29C 64/118

(57) ABSTRACT

Methods and systems include determining a filament cross-section based on an input three-dimensional (3D) design. A sequence of rollers is assembled in a configuration to reshape an input filament from an original cross-section to the determined filament cross-section. The input filament is processed in the sequence of rollers to form an output filament with the determined filament cross-section.

### BACKGROUND

The present invention generally relates to manufacturing techniques and, more particularly, to pre-processing filament material.

There are diverse manufacturing techniques available, including roller forming, pressing, punching, and laser finishing. Each technique produces different types of cross-sectional areas from input raw materials. For example, roller forming enables the fabrication of materials that have a linear dimension too large for a stamping press. By putting holes in the part in-line and providing an end cut, roller forming overcomes limitations imposed by transportation and the roll-forming machine itself. Roller forming can thereby create parts that are very long.

Three-dimensional (3D) printing can create intricate designs and structures, but has a relatively slow output speed compared to other processes.

### SUMMARY

A method for filament processing includes determining a filament cross-section based on an input three-dimensional (3D) design. A sequence of rollers is assembled in a configuration to reshape an input filament from an original cross-section to the determined filament cross-section. The input filament is processed in the sequence of rollers to form an output filament with the determined filament cross-section.

A computer system includes a processor set, one or more computer-readable storage media, and program instructions stored on the one or more storage media. The program instructions cause the processor set to perform operations that include determining a filament cross-section based on an input 3D design, triggering assembly of a sequence of rollers in a configuration to reshape an input filament from an original cross-section to the determined filament cross-section, and triggering processing of the input filament in the sequence of rollers to form an output filament with the determined filament cross-section.

A printing system includes a set of rollers that are assembled to pre-process an input filament, a print head that applies the pre-processed filament to a print in progress, a processor set, one or more computer-readable storage media, and program instructions stored on the one or more storage media. The program instructions cause the processor set to perform operations that include determining a filament cross-section based on an input 3D design, triggering assembly of a sequence of the rollers in a configuration to reshape the input filament from an original cross-section to the determined filament cross-section, and triggering processing of the input filament in the sequence of rollers to form an output filament with the determined filament cross-section.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a printing system that can create three-dimensional (3D) objects using filaments that have been pre-processed to have a predetermined cross-sectional shape, in accordance with an embodiment of the present invention;

FIG. 2 is a block/flow diagram of a method for pre-processing filament using a roller sequence, in accordance with an embodiment of the present invention;

FIG. 3 is a diagram of a sequence of rollers that can be used to progressively change the cross-sectional shape of a filament, in accordance with an embodiment of the present invention;

FIG. 4 is a block/flow diagram of a method to identify a filament cross-sectional shape for use in an input 3D design, in accordance with an embodiment of the present invention; and

FIG. 5 is a block diagram of a computing environment that can be used to perform filament pre-processing, in accordance with an embodiment of the present invention.

### DETAILED DESCRIPTION

Combining different manufacturing modalities can take advantage of the benefits of each. For example, roller forming can be used to shape the cross-section of a filament material before that filament is applied to an in-progress print. This pre-processing makes it possible to use relatively rapid manufacturing techniques to control fine structures of a three-dimensional (3D) printed object while the relatively slow 3D printing system applies the filament using coarse movements.

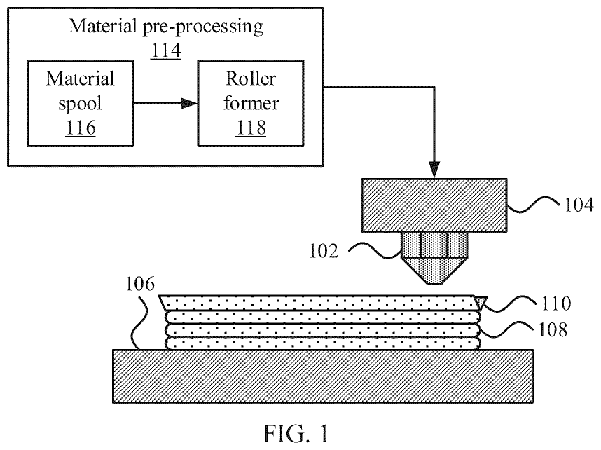

Referring now to FIG. 1, an exemplary 3D printing system is shown. A print head 102 is attached to a gantry 104 or other fixture that moves laterally over a print bed 106. As the print head moves, it extrudes a print material, which is deposited on the print bed 106. After a full layer is deposited, the gantry 104 moves the print head 102 vertically and a next layer is deposited on top of the previous layer. As multiple layers 108 are formed on top of one another, a 3D object is formed in accordance with an input design. In some embodiments, the layers 108 may be formed from polyethylene terephthalate glycol (PETG), a thermoplastic, but it should be understood that other materials may be used instead. This view of a 3D printing system is intended to be purely exemplary and should not be regarded as limiting—other types of 3D printing are contemplated and fall within the scope of the present principles.

The layers 108 may be formed from a filament material. As the filament material passes through the print head 102, it is heated to a temperature that causes it to adhere to the previous layers 108 or print bed 106. In the present embodiments, the filament may have any appropriate cross-section. FIG. 1 illustrates a set of layers 108 having a solid, generally circular or oval cross-section and a pre-processed layer 110 that has a V-shaped cross-section. When the pre-processed filament 110 is applied, it maintains the general shape of the pre-processed filament that is used to create it.

The print head 102 may be adapted to the particular shape of the filament (e.g., having a cross-sectional shape that matches that of the filament), or may have a generic (e.g., circular) outlet. As the pre-processed filament 110 emerges from the print head 102, its temperature is controlled so that it softens enough to bond with the previous layers 108, without melting to such a point that it loses its shape.

The pre-processed filament is formed by material pre-processing 114. A spool 116 of filament material is processed using any appropriate type of fabrication process, such as a roller former 118 that takes material directly off the spool 116 and uses one or more rollers to progressively shape the filament material into a predetermined cross-section. The pre-processed material may then be fed to the print head 102, or may be stored on a second spool until it is needed for printing. Another type of pre-processing that may be used is laser machining, where a precision laser is used to ablate or cut away material from the surface of the filament, which can provide shapes that are more intricate than can be formed with rollers, or that would need an overly complicated series of rollers to achieve.

A wide range of industries, including automotive, aerospace, medical, construction and consumer goods, rely on the production of complex 3D objects with varying geometries and materials, which often demand the use of a combination of manufacturing processes. 3D printing has emerged as a popular method for creating these objects, but it can be a slower process compared to other manufacturing techniques. As a result, pre-processing the filament materials used in 3D printing can improve manufacturing time and overall productivity.

Thus multiple manufacturing processes, such as material forming, pressing, bending, and laser machining, can be combined with 3D printing. By harnessing the potential of these diverse techniques, it becomes possible to achieve a more efficient and streamlined approach to manufacturing complex 3D objects. However, determining the appropriate combination of pre-processing steps for a given object, taking into consideration the required thickness, surface texture, and other specific characteristics of the 3D object being formed, can be challenging.

Underlying technologies, such as machine learning, advanced robotics, and process optimization algorithms, can be used to provide the information needed to make these decisions. By leveraging historical learning and real-time data analysis, the pre-processing stages can be dynamically configured the resultant cross-section area of the filament can be altered based on the specific requirements of the 3D object being manufactured. This enhances the productivity and efficiency of 3D object manufacturing across various industries.

A variety of different filament cross-sections are contemplated for different applications. An exemplary, non-limiting list of cross-sectional shapes includes T-shapes, I-beams honeycomb structures, and asymmetric profiles. Different cross-sectional shapes will provide different physical properties, such as improving strength or allowing multi-material printing. For example, an I-beam shape can be used to create internal structures in automotive or aerospace parts to provide lightweight strength.

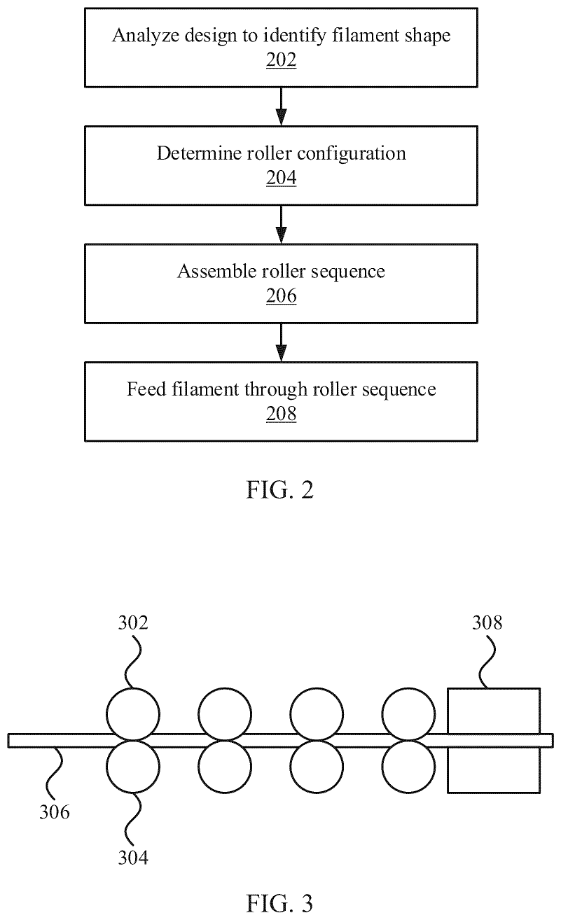

Referring now to FIG. 2, a method for pre-processing filament material is shown. Block 202 analyzes a 3D design to identify shapes that can be formed using alternative fabrication methods, such as by changing the cross-section of the filament before applying it with a 3D printing system. Block 202 can use historical information or preconfigured information to associate structures of the 3D design with potential filament cross-sections that can be fabricated by rolling. For example, a database may include different filament configurations and machining processes. The 3D object's characteristics may be compared to entries in the database to identify similarities and differences. If the historical information is lacking, then preconfigured information may be used as a fallback.

The historical information may include a databased of past 3D designs and their corresponding optimal filament shapes. Supervised and unsupervised learning models may be applied to this database. For example, a convolutional neural network (CNN) may be used to match 3D model geometries with successful filament cross-sections from past designs. The matching may be achieved suing a clustering method, like k nearest neighbor, to find similar historical examples. The preconfigured information may include a set of if-then rules or heuristics that can be used to determine whether a given filament cross-section is appropriate, for example establishing constraints.

For supervised learning, for example, gradient boosting decision trees may be trained on labeled data of the past designs and their optimal filament configurations. These models can predict filament cross-sections based on input features like part geometry, material properties, and performance requirements. For unsupervised learning, dimensionality reduction may be applied to visualize high-dimensional data, so that clusters of similar designs can be identified. Common patterns for filament configuration that work well for each cluster can then be extracted and applied in future designs.

Block 204 determines a roller configuration that can create the determined cross-section. The roller configuration may include one or more rollers that are arranged in sequence to progressively change the shape of a filament passing through until the determined shape has been achieved. The roller sequence may thus include a set of shapes that progress from a roughly circular cross-section in stages to the determined cross-section. Roller selection is based on a gradual deformation, with each set of rollers making incremental changes to the filament's cross section until a specialized shape is created. This incremental process minimizes material stress and defects.

Block 206 then assembles the roller sequence as indicated by block 204. The assembly may be performed manually or automatically, for example using a robotic system, to arrange the rollers in a line such that filament can pass from one roller to the next without substantial deformation. Each roller in the sequence may include a top roller and a down roller, with the filament passing between them. The contours of the rollers forms the filament as it passes through. Block 208 then feeds the filament through the roller sequence to produce the pre-processed filament with the determined cross-section. Heaters may be used to apply heat to the filament as it passes through or leaves the roller sequence, preparing the filament for layer bonding in a 3D manufacturing process.

Real-time feedback can be gathered by monitoring the output of the rollers. For example, cameras, laser imaging, or other sensors may be used to gather information about the cross-section of the filament at the output and/or at any intermediate stage. Information such as filament dimensions, temperature, and extrusion rate may be monitored and compared against expected values. When the real-time data doesn't match the expected values, for example if the filament has a cross-section that does not match the intended shape, then adjustments can be automatically made to the roller sequence by, e.g., changing roller pressure, heating elements, or feed rate to bring the pre-processed filament 110 back within specifications.

In some cases multiple filament strands may be combined and shaped. For example, multiple filaments may feed into a mixing changer before extrusion. The chamber may heat the filaments into a semi-molten state and may use a screw mechanism to blend them. The combined material may then be pushed through a die with a desired cross-sectional shape.

0 Referring now to FIG. 3, a filament pre-processing system is shown. The filament 306 is processed by a sequence of rollers, each roller including a top roller 302 and a down roller 304. The rollers progressively reshape the filament 306, which may begin with a circular or oval cross-section (or any other appropriate cross-section) and may be reshaped to have any appropriate cross-section. After passing through the sequence of rollers, the filament 306 may pass through a heater 308 that brings the filament material up to a temperature for use in the fabrication of the 3D object.

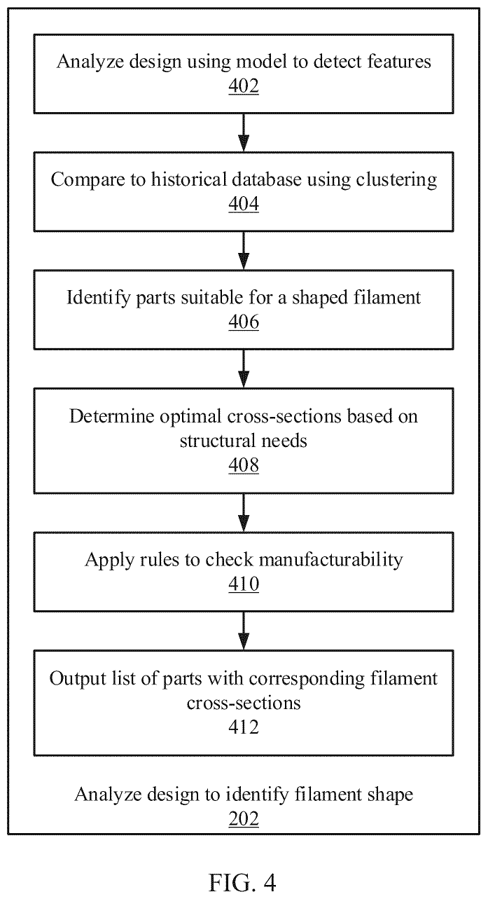

Referring now to FIG. 4, additional information is provided on the analysis of the 3D design in block 202. Block 402 analyzes an input 3D design, for example using a trained CNN, to extract features of the design in the form of a feature vector. This feature vector may be compared to historical examples in block 404, themselves represented as feature vectors in a database and clustered using, e.g., k nearest neighbor clustering. A matching cluster may be used to indicate parts that can be fabricated using filament pre-processing in block 406.

Block 408 determines an optimal cross-section for a filament to form a part. Block 410 applies one or more rules or constraints to ensure manufacturability and block 412 outputs a list of parts with corresponding filament cross-sections that can be used in subsequent steps to configure rollers or other pre-processing systems.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

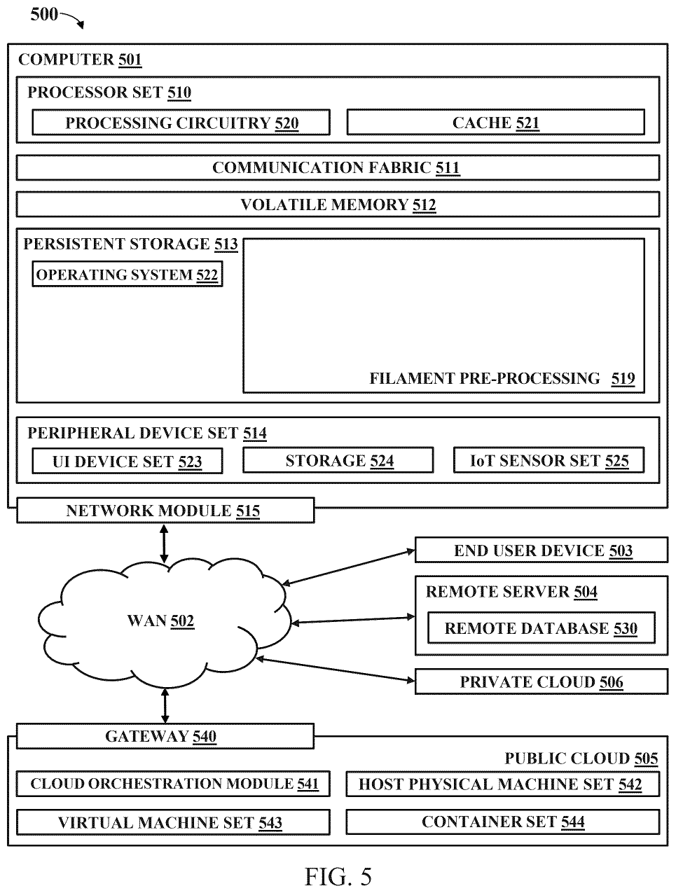

Referring now to FIG. 5, computing environment 500 is shown as an example of an environment for the execution of at least some of the computer code involved in performing the inventive methods, such as filament pre-processing 519. In addition to block 519, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 519, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 519 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 519 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of pre-processing filament material (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for filament processing, comprising:
determining a filament cross-section based on an input three-dimensional (3D) design;
assembling a sequence of rollers in a configuration to reshape an input filament from an original cross-section to the determined filament cross-section; and
processing the input filament in the sequence of rollers to form an output filament with the determined filament cross-section.

2. The method of claim 1, further comprising applying the output filament to a 3D print to create a structure that incorporates the determined filament cross-section.

3. The method of claim 2, wherein applying the output filament includes heating the output filament to a temperature that enables adherence to a previous layer, while preserving the cross-section of the filament.

4. The method of claim 2, wherein applying the output filament uses a print head that has an aperture that matches a shape of the determined filament cross-section.

5. The method of claim 1, wherein determining the filament cross-section includes comparing parts of the 3D design to a database of historical filament examples.

6. The method of claim 5, wherein determining the filament cross-section includes extracting features from the 3D design using a convolutional neural network and comparing a resulting feature vector to clusters of 3D designs in the database.

7. The method of claim 1, further comprising applying laser machining to further reshape the input filament.

8. The method of claim 1, further comprising checking the determined filament cross-section using one or more rules or constraints to ensure manufacturability before assembling the sequence of rollers.

9. The method of claim 1, further comprising monitoring the output filament and modifying the processing to correct defects in the output filament as compared to the determined filament cross-section.

10. A computer system, comprising:
a processor set;
one or more computer-readable storage media; and
program instructions stored on the one or more storage media to cause the processor set to perform operations comprising:
determining a filament cross-section based on an input three-dimensional (3D) design;
triggering assembly of a sequence of rollers in a configuration to reshape an input filament from an original cross-section to the determined filament cross-section; and
triggering processing of the input filament in the sequence of rollers to form an output filament with the determined filament cross-section.

11. The computer system of claim 10, wherein determining the filament cross-section includes comparing parts of the 3D design to a database of historical filament examples.

12. The computer system of claim 11, wherein determining the filament cross-section includes extracting features from the 3D design using a convolutional neural network and comparing a resulting feature vector to clusters of 3D designs in the database.

13. The computer system of claim 10, wherein the operations further comprise checking the determined filament cross-section using one or more rules or constraints to ensure manufacturability before triggering assembly the sequence of rollers.

14. The computer system of claim 10, wherein the operations further comprise monitoring the output filament and modifying the processing to correct defects in the output filament as compared to the determined filament cross-section.

15. A printing system, comprising:
a set of rollers that are assembled to pre-process an input filament;
a print head that applies the pre-processed filament to a print in progress;
a processor set;
one or more computer-readable storage media; and
program instructions stored on the one or more storage media to cause the processor set to perform operations comprising:
determining a filament cross-section based on an input three-dimensional (3D) design;
triggering assembly of a sequence of the rollers in a configuration to reshape the input filament from an original cross-section to the determined filament cross-section; and
triggering processing of the input filament in the sequence of rollers to form an output filament with the determined filament cross-section.

16. The printing system of claim 15, wherein the operations further comprise triggering application of the output filament to a 3D print using the print head to create a structure that incorporates the determined filament cross-section.

17. The printing system of claim 16, wherein applying the output filament includes heating the output filament to a temperature that enables adherence to a previous layer, while preserving the cross-section of the filament.

18. The printing system of claim 16, wherein the print head has an aperture that matches a shape of the determined filament cross-section.

19. The print system of claim 15, further comprising a laser to further reshape the input filament.

20. The print system of claim 15, further comprising a sensor to monitor the output filament, wherein the operations further comprise modifying the processing to correct defects in the output filament as compared to the determined filament cross-section.
